(19) United States
(12) Patent Application Publication
(10) Pub. No.: US 2010/0077333 A1
(43) Pub. Date: Mar. 25, 2010

(54) METHOD AND APPARATUS FOR NON-HIERARCHICAL INPUT OF FILE ATTRIBUTES

(75) Inventors: Gyung Hye Yang, Seoul (KR); Eun Young Lim, Seoul (KR); Ji Young Kwahk, Seongnam-si (KR); Sang Woong Hwang, Seongnam-si (KR); Ju Yun Sung, Seoul (KR); Jee Young Her, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/550,865

(22) Filed: Aug. 31, 2009

(30) Foreign Application Priority Data
Sep. 24, 2008 (KR) 10-2008-0093529

(51) Int. Cl. G06F 3/048; G06F 3/041; G06F 3/00; G06F 15/00

(52) U.S. Cl. 715/769; 715/780; 345/173; 715/700; 715/764; 702/130

(57) ABSTRACT

The present invention discloses a method and an apparatus to manage files by storing attribute information of the files in a non-hierarchical structure. At least one file and an attribute input window may be displayed on a display unit. At least one file attribute may be input through the window and displayed in the form of a graphical user interface object, such as an icon. By dragging and dropping either the file to the icon or the icon to the file, the file attribute may be input into the file in a non-hierarchical structure.

### CROSS REFERENCE TO RELATED APPLICATION

This application claims priority from and the benefit of Korean Patent Application No. 2008-0093529, filed on Sep. 24, 2008, which is hereby incorporated by reference for all purposes as if fully set forth herein.

### BACKGROUND OF THE INVENTION

1. Field of the Invention

Exemplary embodiments of the present invention relate to an input of file attributes and, in particular, to a method and an apparatus for non-hierarchically inputting attribute information of files to allow an integrated management of files.

2. Description of the Background

In general, a file which includes a large variety of data, such as text data and multimedia data (e.g., music, images, videos), is created and stored together with related attribute information. For example, attribute information of a file may include a creation time, a file type, a creator, a file name, and/or a play time. Such attribute information may be stored according to predefined rules.

Typically attribute information may be stored in a hierarchical structure, which may resemble a tree. For example, attribute information of a multimedia file may have a highest folder ‘attribute information’ and first-grade lower folders, such as ‘creation information’ and ‘play information,’ which may be a level below the highest folder ‘attribute information.’ Furthermore, second-grade lower folders such as ‘creation time,’ ‘file type,’ and ‘file name’ may exist below the first-grade lower folder ‘creation information.’ In addition, data about a creation time may exist in the second-grade lower folder ‘creation time.’ Similarly, all attribute information about a specific file may be hierarchically stored in a hierarchical structure composed of higher and lower graded folders.

A hierarchical structure of file attributes may vary according to a device which creates a file. For instance, in the example described above, information about a creation time is stored in the second-grade lower folder ‘creation time,’ which is below the first-grade lower folder ‘creation information,’ which is below the highest folder ‘attribute information’ in the hierarchical structure. However, in another device, corresponding folders may follow a different hierarchical structure or may have different names. Unequal hierarchical structures of file attributes may restrict the favorable execution of some functions, such as searching for files and performing a specific operation using a keyword. Accordingly, similar or exact execution of functions in various devices may be expected only when file attributes are stored using the same hierarchical structure.

When a specific file is searched among files created with different attribute hierarchies by different devices, the file may only be found among files having the same attribute hierarchy. In addition, when a keyword is used to search for a specific file among files which have attributes arranged in different folder hierarchies, some files may not be retrieved due to different attribute depths in folders or due to different folder names.

As related technology has advanced, a user may need to integrate management of all files instead of individually managing all files, which may be created by different devices. If the files have different attribute hierarchies, the user may not efficiently and precisely search for a desired file. Accordingly, an approach to allow an integrated, simultaneous, and efficient management of files created by different devices is needed.

### SUMMARY OF THE INVENTION

Exemplary embodiments of the present invention disclose a method and an apparatus for providing a non-hierarchical input and an integrated management of file attributes.

Additional features of the invention will be set forth in the description which follows, and in part will be apparent from the description, or may be learned by practice of the invention.

Exemplary embodiments of the present invention disclose a method for inputting file attribute information. The method includes displaying a file on a display unit, and displaying an attribute input window on the display unit. The method further comprises receiving an input of the attribute information through the attribute input window, generating at least one graphical user interface object corresponding to the attribute information input, and displaying the at least one graphical user interface object. The method further comprises inputting the attribute information provided by the at least one graphical user interface object into the file in response to detecting an input event.

Exemplary embodiments of the present invention also disclose an apparatus for inputting file attribute information. The apparatus includes a display unit, an input processing unit, and a control unit. The display unit is displays a file and at least one graphical user interface object corresponding to the attribute information. The input processing unit receives an input of the attribute information and generates signals corresponding to the received input. The control unit receives a signal corresponding to an input event from the input processing unit and inputs the attribute information, provided by the at least one graphical user interface object, into the file.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a schematic configuration of a system for an integrated management of file attributes according to exemplary embodiments of the present invention.

FIG. 2A, FIG. 2B, FIG. 2C, and FIG. 2D are exemplary views illustrating a process of inputting attribute information into a file according to exemplary embodiments of the present invention.

FIG. 3A and FIG. 3B are views illustrating hierarchical and non-hierarchical structures of file attributes according to exemplary embodiments of the present invention.

FIG. 4A and FIG. 4B are exemplary views illustrating a process of creating an attribute input window according to exemplary embodiments of the present invention.

FIG. 5 is a flow diagram of a method to input attribute information into a file according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art.

Furthermore, well known or widely used techniques, elements, structures, and processes may not be described or illustrated in detail to avoid obscuring the essence of the present invention. Although the drawings represent exemplary embodiments of the invention, the drawings are not necessarily drawn to scale and certain features may be exaggerated or omitted in order to better illustrate and explain the present invention. In the drawings, like reference numerals denote like elements.

Files stored in different devices can be managed depending upon the structural properties established in each device. However, an integrated management of files stored individually in different devices should be free from the structural properties of files in each device. For example, to obtain exact results of a file search using specific attribute information, file attributes stored in every device should have the same structure. For an integrated management of files and for providing precise search results of files, exemplary embodiments of the present invention provide a method for inputting attribute information into a file. Attribute information may also be referred to as metadata, which may refer to data related to file properties.

Hereinafter, exemplary embodiments of the present invention are described in detail with reference to the accompanying drawings.

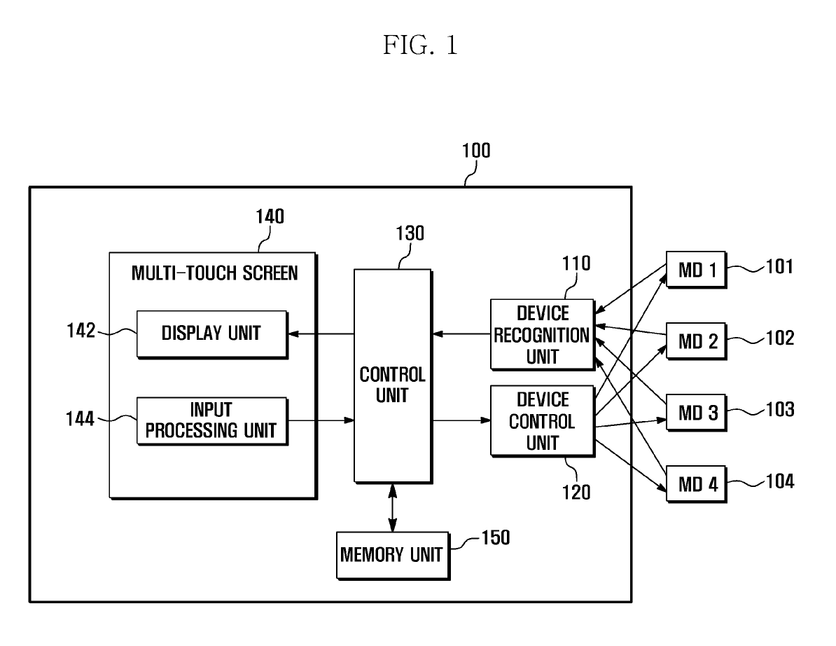

FIG. 1 is a block diagram illustrating a schematic configuration of a system for an integrated management of file attributes according to exemplary embodiments of the present invention.

Referring to FIG. 1, the system may include a media management apparatus 100 and at least one mobile device (MD). Four mobile devices 101, 102, 103, and 104 are illustrated in FIG. 1. The media management apparatus 100 may include a device recognition unit 110, a device control unit 120, a control unit 130, a multi-touch screen 140, and a memory unit 150. The media management apparatus 100 may be a host terminal to which the mobile devices 101, 102, 103, and 104 are connected as client terminals. The media management apparatus 100 may manage tasks such as reading, writing, and searching of files stored in the respective mobile devices 101, 102, 103, and 104. In addition, the media management apparatus 100 may manage multimedia files stored in the mobile devices 101, 102, 103, and 104.

The media management apparatus 100 may include, but not be limited to, one of a television, a table top display, a large format display (LFD), and their equivalents, which may also perform at least one function of the media management apparatus 100. In some cases, the media management apparatus 100 may be connected or attached to one of a television, a table top display, a large format display (LFD), and their equivalents.

When the mobile devices 101, 102, 103, and 104 are connected to the media management apparatus 100, a device recognition unit 110 may detect the connection of the mobile devices 101, 102, 103, and 104. That is, the device recognition unit 110 may detect that at least one of the mobile devices 101, 102, 103, and 104 is connected or disconnected. A device control unit 120 may control the interactions with the mobile devices 101, 102, 103, and 104. The interactions may include, for example, reading, writing, and searching for files stored in the mobile devices 101, 102, 103, and 104.

A control unit 130 may control the entire operation of the media management apparatus 100. In particular, the control unit 130 may non-hierarchically store attribute information of multimedia files into a memory unit 150 based on a user's input, to allow integrated management of file attributes. The non-hierarchical structure of file attributes may allow an exact search of desired files regardless of the hierarchical structure or different folder names in each device.

A multi-touch screen 140 may include a display unit 142 and an input processing unit 144. In some cases, the display unit 142 may include a screen surface or a touch screen. The display unit 142 may perform a display function, and the input processing unit 144 may perform an input function. The multi-touch screen 140 may receive an input signal by sensing a user's touch activity on the surface (i.e., on a screen surface) of the display unit 142, instead of using a conventional key press input. The multi-touch screen 140 may also sense two or more touch activities simultaneously performed on the screen surface. The media management apparatus 100 may further include any other input and/or display device.

The display unit 142 provides a screen to display a state of the media management apparatus 100, at least one file stored in the mobile devices 101, 102, 103, and 104, and a graphical user interface (GUI) for at least one file attribute. The display unit 142 may include a liquid crystal display (LCD) or an equivalent thereof. If the display unit 142 includes an LCD, the display unit 142 may include an LCD controller, a memory, an LCD unit, and any other component for operating the LCD. The display unit 142 may present the state, operation, and other information of the media management apparatus 100 in several forms, such as, for example, in text, image, animation, and/or icon form.

In some cases, the input processing unit 144 may include the display unit 142. The input processing unit 144 may generate a signal that corresponds to the user's input. The input processing unit 144 may include a touch sensing module (not shown) and a signal converting module (not shown). When the user provides an input event (i.e., user enters input) to the multi-touch screen 140, the touch sensing module may detect a change in a physical parameter, such as, for example, a resistance or capacitance, and may determine that an input event has occurred. The signal converting module may convert the change in the physical parameter caused by the input event into a digital signal.

The control unit 130 may receive the digital signal from the input processing unit 144. From the coordinate value (provided by the digital signal) of the input event, the control unit 130 may determine whether an input event is a touch activity or a drag activity. A touch activity is a touch input provided by a user. A drag activity is an input provided by a user wherein the point of input moves while the input such as a touch or a press of a button is continued. Particularly, if the input event is a drag-and-drop event for a specific file or a specific file attribute icon, the control unit 130 may retrieve information associated with the specific file or file attribute icon, and may then acquire the coordinate value of a drop location after a drag activity. A drag-and-drop event may be considered a request for inputting attribute information into a selected file, as shall be explained in further detail below.

The input processing unit 144 may further include at least one sensor for receiving, as an input, a special activity from a user. The special activities may include, but not be limited to, a breath, sound, gesture, pose, and any other action or expression of the user. For example, if the user blows his or her breath on the display unit 142, the input processing unit 144 can detect the user's activity through a temperature sensor for sensing the temperature of the display unit 142. In general, blowing of the user's breath may be detected by any suitable sensor or device, including, for example, a microphone, an image sensor, an inertial sensor, an accelerometer, a gyroscope, an infrared sensor, and a tactile sensor.

The memory unit 150 may include a program memory region and a data memory region. The program memory region may store a variety of programs for performing functions of the media management apparatus 100. The data memory region may store user input data and data created while programs are executed on the media management apparatus 100. Additionally, the data memory region may store attribute information of files in a non-hierarchical structure, instead of a hierarchical structure.

Hereinafter, a process for inputting attribute information into files retrieved from the mobile devices connected to the media management apparatus 100 will be described in detail.

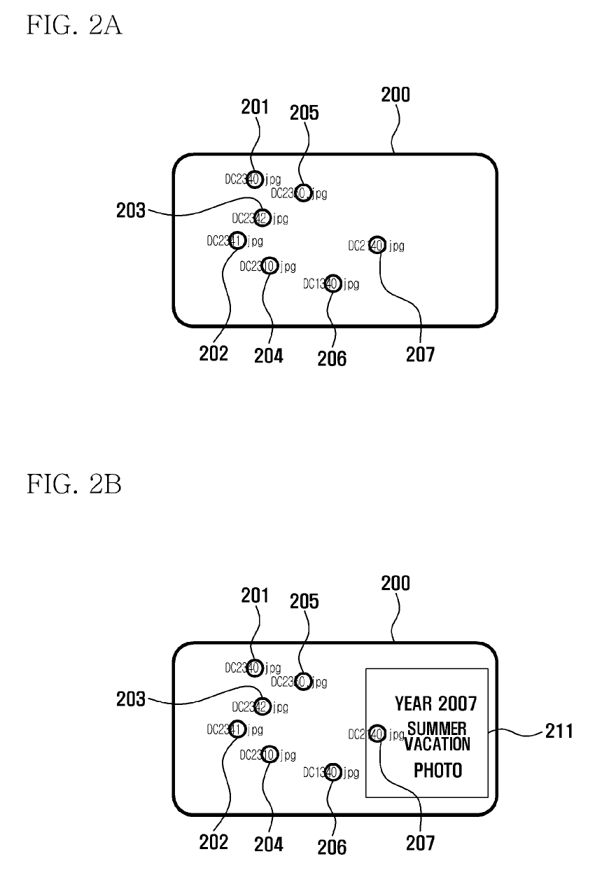

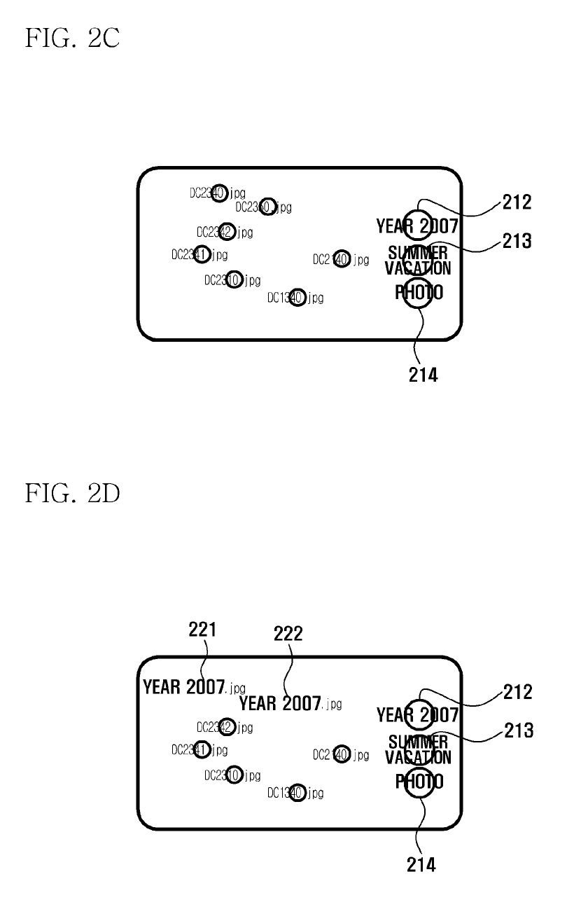

FIG. 2A, FIG. 2B, FIG. 2C, and FIG. 2D are exemplary views illustrating a process of inputting attribute information into a file according to exemplary embodiments of the present invention.

Referring to FIG. 1, when the mobile devices 101, 102, 103, and 104 (i.e., client terminals) are connected to the media management apparatus 100 (i.e., a host terminal), the device recognition unit 110 may detect connection of the mobile devices 101, 102, 103, and 104. Then, as shown in FIG. 2A, files stored in the connected mobile devices 101, 102, 103, and 104 may be displayed on a screen 200 of the display unit 142. The files displayed on the display unit 142 may be graphical user interface (GUI) objects. A GUI object may refer to a graphic-based object for providing user interface.

As shown in FIG. 2A, FIG. 2B, FIG. 2C, and FIG. 2D, multimedia files can be displayed on the multi-touch screen 140. In FIG. 2A, files ‘DC2340.jpg’ (201), ‘DC2341.jpg’ (202), ‘DC2342.jpg’ (203), ‘DC2310.jpg’ (204), ‘DC2350.jpg’ (205), ‘DC1340.jpg’ (206), and ‘DC2140.jpg’ (207) have been retrieved from mobile devices 101, 102, 103, and 104. Other types of files, such as text files, may also be displayed, in some cases, as GUI objects.

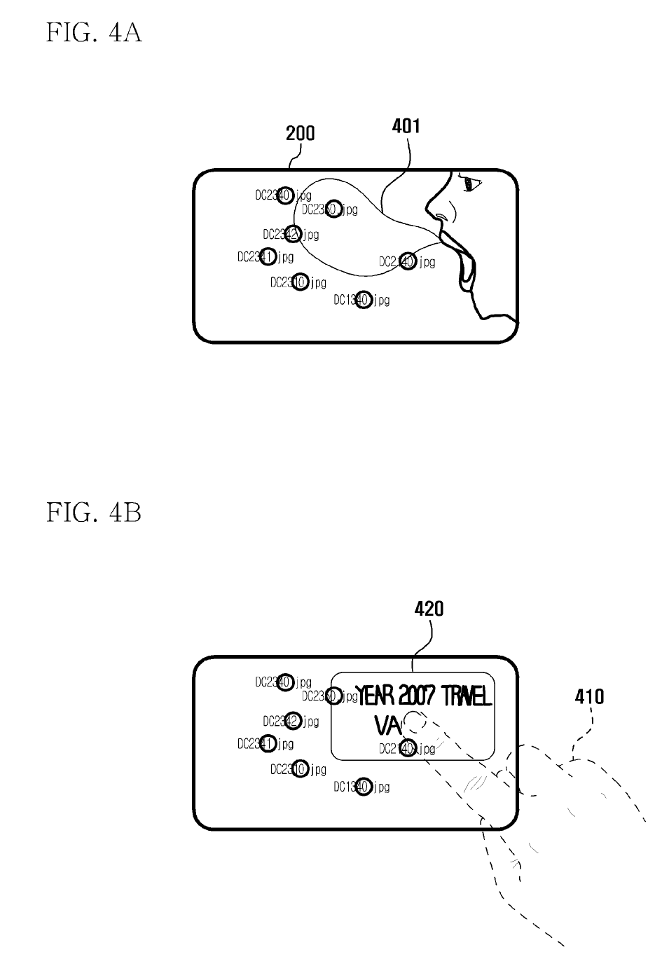

Referring to FIG. 2B, an attribute input window 211 and files 201, 202, 203, 204, 205, 206, and 207 retrieved from the mobile devices 101, 102, 103, and 104 may be displayed on the screen 200 of the display unit 142. The attribute input window 211 may have an overlay display format, and may be semi-transparently laid at a specified location on the display unit 142. A method for creating the attribute input window will be described below with reference to FIG. 4A and FIG. 4B.

The attribute input window 211 may receive, from a user, attribute information to be input into the files. When inputting attribute information in the attribute input window 211, the user can use a keypad which may be separately provided in the media management apparatus 100, or a contact device, such as the user's finger or a stylus pen, to directly touch the display unit 142. In FIG. 2B, the attribute information provided by the user in the attribute input window 211 is ‘year 2007,’ ‘summer vacation,’ and ‘photo.’

As shown in FIG. 2B, text inputs in the attribute input window 211 can be divided into at least one individual attribute based on a predefined rule, such as, for example, shifting lines or spacing words. Each of the divided individual attributes may then be represented in the form of a GUI object, such as an icon. For example, the three attribute inputs ‘year 2007,’ ‘summer vacation,’ and ‘photo’ as shown in FIG. 2B, may be divided and displayed as icons 212, 213, and 214, respectively, on the display unit 142, as shown in FIG. 2C.

Icons 212, 213, and 214 may be GUI objects. GUI objects may, in general, allow the user to easily perform a subsequent input action, such as, for example, a drag-and-drop action. In addition, when attribute information is input to a file by the user's input action, the input attribute information may be stored in a non-hierarchical structure and may be used as keywords for an efficient search.

Referring to FIG. 2C, when file attribute icons 212, 213, and 214 are displayed on the screen 200 of the display unit 142 together with the files retrieved from the mobile devices 101, 102, 103, and 104, the user can select one of the file attribute icons and may input the selected file attribute into at least one file by using a drag-and-drop action. For example, to input a file attribute ‘year 2007’ into a file ‘DC2340.jpg,’ the user may select a target icon 212 corresponding to ‘year 2007’ by touching it with a contact device (e.g., the user's finger or stylus pen), and then dragging the touched icon 212 towards the destination file ‘DC2340.jpg’ icon by moving the contact device on the screen 200. Thereafter, a user may drop the dragged icon 212 onto the destination file ‘DC2340.jpg’ icon by removing the contact device from the screen 200. In some cases, the user may touch the file ‘DC2340.jpg’ icon, drag it toward the ‘year 2007’ icon, and drop the file ‘DC2340.jpg’ icon onto the ‘year 2007’ icon. Such drag-and-drop actions may provide easier, efficient, and convenient input of attributes into files.

FIG. 2D shows a case where a file attribute ‘year 2007’ is input into two files, namely ‘DC2340.jpg’ and ‘DC2350.jpg’ according to exemplary embodiments of the present invention. As described above, to input file attributes into files, the user may select at least one file attribute icon and may drag the file attribute icon towards a file icon, or alternatively, the user may select at least one file and drag the selected file icons towards the file attribute icon. In some cases, after the drag-and-drop event is complete, the file attribute that has been input may be displayed as a file name, as indicated by reference numbers 221 and 222 in FIG. 2D. The inputted file attribute may be semi-transparently displayed on the file name, arranged in parallel with the file name, or, in some cases, may not be displayed.

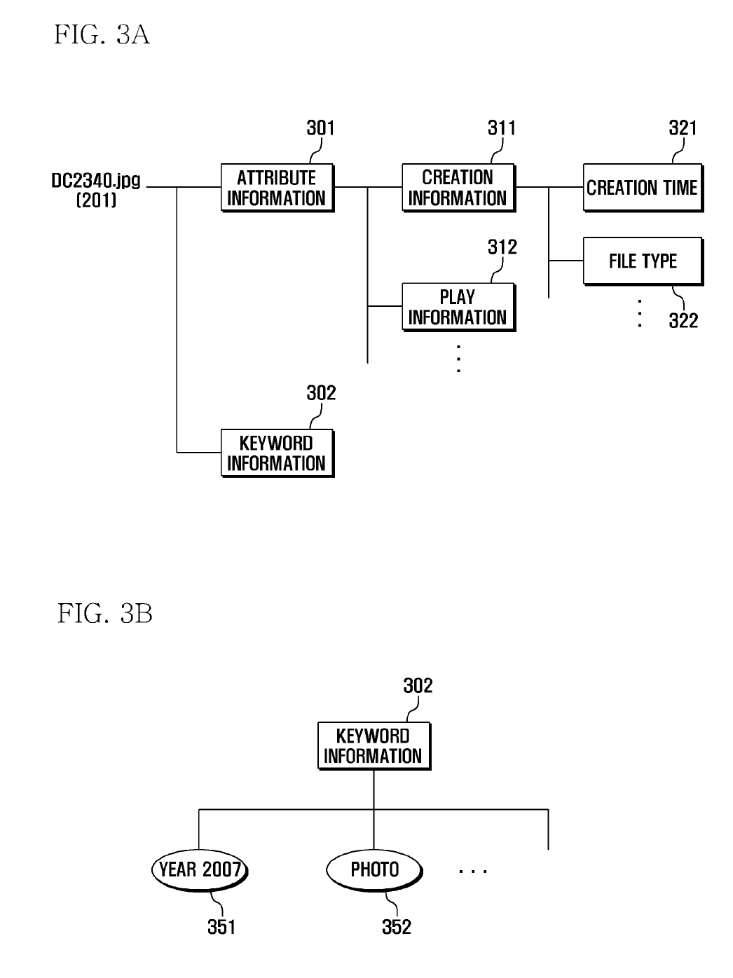

The input processing unit 144, shown in FIG. 1, may detect two or more touches that may simultaneously occur on the screen 200. For example, a user can select two or more attribute icons and may complete a drag-and-drop action simultaneously. In some cases, a user can select two or more file icons and then complete a drag-and-drop action simultaneously. When two or more file attributes are input into one file, such attributes are stored in a non-hierarchical structure, as shall be described hereinafter with reference to FIG. 3A and FIG. 3B.

FIG. 3A and FIG. 3B are views illustrating hierarchical and non-hierarchical structures of file attributes according to exemplary embodiments of the present invention. For example, as shown in FIG. 3A and FIG. 3B, file attributes, such as ‘year 2007’ and ‘photo,’ may be input into a ‘DC2340.jpg’ file 201.

Referring to FIG. 3A, the ‘DC2340.jpg’ file 201 may be created and stored in one of the mobile devices 101, 102, 103, and 104, and retrieved by the media management apparatus 100. When created and stored in one of the mobile devices 101, 102, 103, and 104, the ‘DC2340.jpg’ file 201 may have file attributes of a hierarchical structure. For example, file 201 may have the highest folder ‘attribute information’ 301, and first-grade lower folders such as ‘creation information’ 311 and ‘play information’ 312, which belong under the highest folder ‘attribute information’ 301. Furthermore, second-grade lower folders, such as ‘creation time’ 321 and ‘file type’ 322, may exist below the first-grade lower folder ‘creation information’ 311. Accordingly, the ‘DC2340.jpg’ file 201 may have file attributes stored in a tree structure by the mobile device.

However, after the mobile device is connected to the media management apparatus 100, and further after the files in the mobile device are retrieved by the media management apparatus 100, a file attribute input may be stored in a non-hierarchical structure. For example, at least one file attribute may be input into at least one file through an input action such as a drag-and-drop event, as discussed above with reference to FIG. 2D. The input file attribute may be stored in a predefined folder, such as, for example, a ‘keyword information’ folder 302, in a non-hierarchical structure, as shown in FIG. 3A.

Referring to FIG. 3B, if file attributes such as ‘year 2007’ 351 and ‘photo’ 352 are input into a ‘DC2340.jpg’ file 201, such file attributes 351 and 352 may be stored in a parallel arrangement under a predefined single folder such as a ‘keyword information’ folder 302.

Therefore, if the user performs a search using a keyword such as ‘year 2007’ or ‘photo,’ a ‘DC2340.jpg’ file can be found by means of file attributes stored in a non-hierarchical structure having a ‘keyword information’ folder 302.

FIG. 4A and FIG. 4B are exemplary views illustrating a process of creating an attribute input window according to exemplary embodiments of the present invention.

As described above and shown in FIG. 2B, when the media files are displayed on the screen 200 of the media management apparatus 100, the attribute input window 211 for receiving a file attribute input may also be displayed on the screen 200. Furthermore, the attribute input window 211 may be created depending on the user's predefined activity including, but not limited to, a special key input, a predefined sound input, a given gesture or pose input, and/or taking a specific picture. For example, if a sensor detects a wink gesture of the user, the attribute input window 211 may be created.

FIG. 4A shows the creation of the attribute input window 211. Referring to FIG. 4A, the attribute input window 211 may be created when the user's breath 401 is detected. Specifically, if a user blows a breath 401 toward the screen 200 on which the files retrieved from the mobile devices 101, 102, 103, and 104 are displayed, any suitable sensor may be used to detect blowing of the user's breath. This detection may be considered as instructions to generate the attribute input window 211. Accordingly, the media management apparatus 100 may generate the attribute input window 211 to be semi-transparently displayed on the screen 200. As discussed above, if the attribute input window 211 is generated based on the user's breath, a temperature sensor or any other suitable sensor/detector may detect the blowing of the user's breath.

In some cases, the attribute input window may also be created based on other activities of the user, such as a key input, a sound input, a gesture or pose input, and/or taking a picture.

Referring now to FIG. 4B, after being created, the attribute input window 420 may receive a text input of file attributes from the user. To input a text in the attribute input window 420, the user can use a keypad or a touching tool, such as a contact device (e.g., user's finger 410, stylus pen). Inputted file attributes are then displayed in the attribute input window 420.

Additionally, if another breath is detected on the screen 200 after creation of the attribute input window 420, the media management apparatus may remove the currently displayed window 420 from the screen 200, and may generate a new attribute input window. Furthermore, the media management apparatus 100 may regulate the display size of the attribute input window 420. For example, the attribute input window 420 may be enlarged when the entire text input exceeds the currently displayed size of the window. Also, in some cases, the attribute input window 420 may disappear if no input is received for a given time after the attribute input window 420 is created or after the text is input. The attribute input window 420 may be used to search for files as well as to provide file attribute input. That is, the user can use the attribute input window 420 to input keywords for a file search.

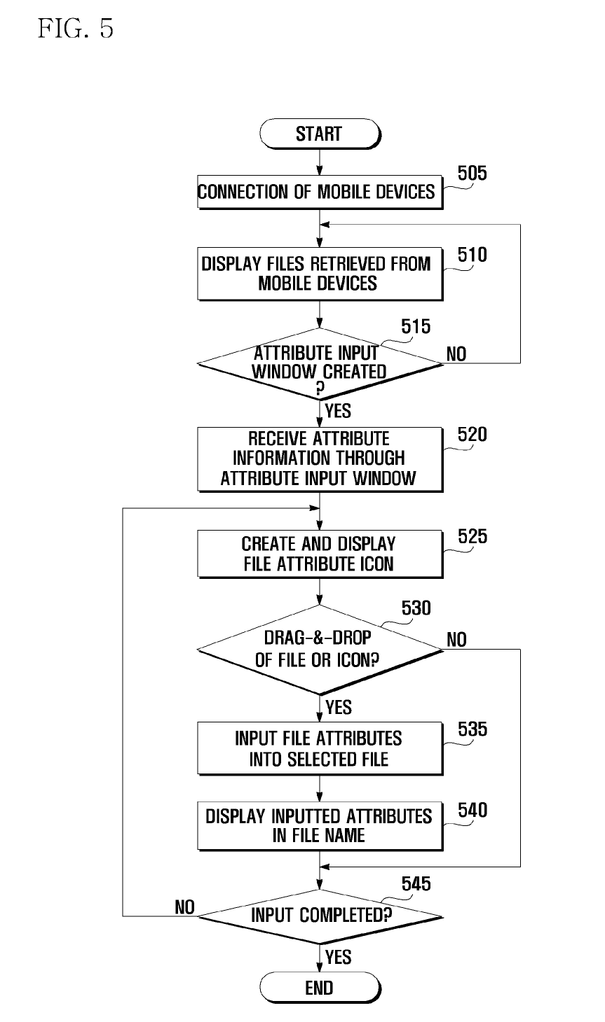

FIG. 5 is a flow diagram of a method to input attribute information into a file according to exemplary embodiments of the present invention.

Referring to FIG. 1 and FIG. 5, the device recognition unit 110 may detect connection of at least one of the mobile devices 101, 102, 103, and 104 to the media management apparatus 100 (step 505).

Next, the device control unit 120 may retrieve files from the mobile devices 101, 102, 103, and 104, and may then display the retrieved files on the display unit 142 under control of the control unit 130 (step 510).

Next, the control unit 130 may determine whether the attribute input window 211 should be generated based on an instruction defined by the user (step 515). As previously discussed with reference to FIG. 4A and FIG. 4B, the user defined instruction may be a breath blowing, and/or a key input.

If the attribute input window 211 is created, the control unit 130 may receive an input of attribute information through the attribute input window 211 (step 520). If the attribute input window 211 is not created, the control unit 130 may return to step 510. As discussed above, an input of attribute information may be performed through a keypad or via a contact device, such as the user's finger and/or a stylus pen.

Next, the control unit 130 may create an attribute icon representing the input attribute information, and may display the attribute icon on the display unit 142 (step 525).

Next, the control unit 130 may determine whether an input event, such as a drag-and-drop event, configured to input attribute information into a file, has occurred after a file or icon selection by a user (step 530).

If an input event for file attribute input has occurred, the control unit 130 may input attribute information into the selected file (step 535).

The control unit 130 may then instruct the display unit 142 to display the inputted file attribute as a file name, as shown, for example, by 221 and 222 in FIG. 2D (step 540).

If an input event for file attribute input has not occurred in step 530 and/or after the inputted file attribute has been displayed as a file name, the control unit 130 may determine whether inputting attribute information is complete (step 545). For example, the control unit 130 may monitor whether a given time has elapsed after the display of the attribute information in step 540 and/or if no drag-and-drop event occurred in step 530. If the given time elapses, the control unit 130 may end the procedure to input attribute information into a file. If a given time has not elapsed, the control unit 130 may return to step 525.

As discussed hereinabove, exemplary embodiments of the present invention disclose inputting file attributes in a non-hierarchical structure to allow an efficient keyword search of files regardless of the folder structures of file attributes stored in different mobile devices. Moreover, exemplary embodiments of the present invention disclose a method to easily input file attributes into files by using a drag-and-drop technique. The method may not require inputting a keyword one by one into each file, and a user may freely input metadata into contents regardless of the type of metadata in the contents. Exemplary embodiments of the present invention also disclose providing a temporary, small-sized attribute input window in the apparatus without providing an additional input section. Accordingly, small-sized devices or players may benefit from the reduction in spatial requirements. Exemplary embodiments of the present invention also disclose using a single input window to search for and input data.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for inputting file attribute information, the method comprising:
displaying a file on a display unit;
displaying an attribute input window on the display unit;
receiving an input of attribute information through the attribute input window;
displaying at least one graphical user interface object corresponding to the attribute information input; and
inputting the attribute information provided by the at least one graphical user interface object into the file in response to detecting an input event.

2. The method of claim 1, further comprising retrieving the file from a client terminal, and wherein displaying the file on the display unit comprises displaying the file on the display unit of a host terminal connected to the client terminal.

3. The method of claim 1, wherein the file is displayed as a graphical user interface object.

4. The method of claim 1, further comprising:
storing, in a non-hierarchical structure, the attribute information inputted into the file.

5. The method of claim 1, wherein the input event comprises a drag-and-drop event.

6. The method of claim 1, further comprising:
receiving an instruction to display the attribute input window.

7. The method of claim 6, wherein receiving the instruction comprises detecting a change in a temperature of the display unit.

8. The method of claim 6, wherein receiving the instruction comprises detecting a blowing of a user's breath.

9. The method of claim 6, wherein receiving the instruction comprises detecting one of a special key input, a sound input, a gesture, a pose input, and taking a specific picture.

10. An apparatus for inputting file attribute information, the apparatus comprising:
a display unit to display a file and at least one graphical user interface object corresponding to the attribute information;
an input processing unit to receive an input of the attribute information and to generate signals corresponding to the received input; and
a control unit to receive a signal corresponding to an input event from the input processing unit, and to input the attribute information, provided by the at least one graphical user interface object, into the file.

11. The apparatus of claim 10, further comprising:
a device recognition unit to detect a connection of a client terminal; and
a device control unit to retrieve the file from the client terminal, the device control unit being controlled by the control unit.

12. The apparatus of claim 10, further comprising:
a memory unit to store, in a non-hierarchical structure, the attribute information.

13. The apparatus of claim 10, wherein the control unit generates the at least one graphical user interface object in response to the input processing unit receiving the input of the attribute information.

14. The apparatus of claim 10, wherein the control unit displays, on the display unit, an attribute input window after receiving a request signal from the input processing unit to display the attribute input window.

15. The apparatus of claim 10, wherein the input event comprises a drag-and-drop event.

16. The apparatus of claim 10, wherein the input processing unit comprises a touch sensing module to detect a change in a physical parameter according to a touch input provided by a user of the apparatus.

17. The apparatus of claim 14, wherein the input processing unit provides the request signal based on a change in temperature of the display unit.

18. The apparatus of claim 14, wherein the input processing unit provides the request signal based on a blowing of a breath of a user of the apparatus.

19. The apparatus of claim 14, wherein the input processing unit comprises at least one sensor to generate the request signal after receiving an input from a user of the apparatus.

20. The apparatus of claim 14, wherein the input processing unit generates the request signal after detecting one of a key input, a sound input, a gesture, a pose input, and taking a specific picture.
